(19) United States
(12) Patent Application Publication
(10) Pub. No.: US 2018/0225765 A1
(43) Pub. Date: Aug. 9, 2018

(54) Financial Risk Management Assessment System and Method for Assessing Financial Risk

(71) Applicant: FINMASON, INC., Boston, MA (US)

(72) Inventor: Lawrence Kendrick Wakeman, Scituate, MA (US)

(21) Appl. No.: 15/749,424

(22) PCT Filed: Aug. 3, 2016
(86) PCT No.: PCT/US2016/045357

§ 371 Date: Jan. 31, 2018

Related U.S. Application Data
(60) Provisional application No. 62/200,369, filed on Aug. 3, 2015.

(51) Int. Cl. G06Q 40/06; G06Q 30/02

(52) U.S. Cl. CPC G06Q 40/06; G06Q 30/0201

(57) ABSTRACT

A system configured to assess financial risk tolerance and an appropriate method to assess an investor's financial risk tolerance, wherein the system presents to the investor a series of financial parameters and based on the investor's responses to the financial parameters, the system develops a series of portfolios for the investor to choose from and then the system generates for the investor a financial risk tolerance score. An investor chooses which retirement plan he/she is more comfortable with until he/she has reached the plan that has the appropriate amount of risk to reward ratio for them.

### CROSS REFERENCE TO RELATED APPLICATION

This application takes priority from and claims the benefit of U.S. Provisional Patent Application 62/200369 filed on Aug. 3, 2015, the contents of which are herein incorporated by reference.

### BACKGROUND OF THE INVENTION

### Field of the Invention

The instant invention relates generally to decision making, and more specifically methods providing financial advice based on risk assessment.

### Description of Related Art

Several approaches exist for making financial investment opportunities more accessible to the individual investor. Mobile phone apps and user-friendly websites are cropping up to allow individual users to pick and choose from a variety of financial assets. While these advances have helped to provide more investment options, however, they have failed to provide meaningful analytical measures of investments to help investors choose which options are really best for them.

For example, to help investors determine what retirement strategy is best for them, some analytical platforms provide measures of the amount of savings available at retirement based on what types of assets are in their current portfolio. However, this calculation can be complicated by several variables, such as assets with high volatility, changes in investor contribution amounts, etc. Several currently available platforms run Monte Carlo simulations based on probabilistic assumptions about these variables to determine a range of possible performance outcomes. While flexible, this approach is computationally intensive. Each simulation can require more computational power than what is available on many mobile devices and can take several minutes to run-enough time for many users to lose interest.

Furthermore, many currently available analytical platforms for retirement planning require estimates for portfolio expected return and volatility to run the Monte Carlo analysis. Thus, such platforms often only provide performance metrics for a generic portfolio with given amounts of each broad asset category, e.g., stocks, bonds, etc., rather than for a particular asset or portfolio of assets.

Accordingly, there remains a need for customizable, efficient ways to estimate a value of a portfolio at retirement.

Planning for retirement is a complicated and difficult process. The numerous methods exist to model how an individual's investments will perform. Many of them are dependent on how aggressive an investor is willing to be with their assets.

A simple and commonly used method of determining financial risk tolerance in financial planning is to simply ask the investor how risky they would like to be. The response can be as specific as a number within a range, such as from 1-100, or with subjective responses like aggressive or passive. These methods can be effective, however the investor may not be able to give the most accurate response.

Other methods may try to assess financial risk tolerance by asking other questions to determine how risky the investor's personality might be. Numerous psychological tests exist to determine and quantify the riskiness of a person's personality, which can then be used to assess which type of investments they would choose. These methods can be effective, but they fail to account for a person's ability to choose more or less risky options based on the subject matter they are assessing.

Investors may choose to use an investment professional to assist them with their investments. These professionals may attempt to measure their client's financial risk tolerance through the personal experiences they have with the client or by asking the client similar questions to the ones mentioned above. These methods are also subjectively and could lead to less accurate results.

### SUMMARY OF THE INVENTION

The instant apparatus, as illustrated herein, is not anticipated, rendered obvious, or present in any of the prior art mechanisms, either alone or in any combination thereof. The present invention relates to an improved method and system for measuring financial risk tolerance. The method and system mark notable improvements in the art financial planning.

Therefore, it is an object of the instant system to provide a system, method, process and accompanying apparatuses for measuring financial risk tolerance.

An additional object of the present invention is to provide a method of quantifying financial risk tolerance.

It is an object of the present invention to provide a method of measuring financial risk tolerance that is easy for a user to access from home.

Another object of the present invention is to provide a means for advertising financial portfolios. An embodiment of the present invention includes offering the investor several portfolios to choose from and, when they choose the same one twice, they are shown which investment portfolio that is and offers the investor the ability to invest in that portfolio.

It is an object of the present invention to provide a method of measuring financial risk tolerance that is easy for an investor to operate.

The method of assessing financial risk tolerance comprises calculating multiple theoretical financial outcomes, prompting an investor to choose which is the most preferable, and repeating the process until the investor has a plan they are satisfied with.

There has thus been outlined, rather broadly, the more important features of the versatile systems, apparatuses and accompany methods for measuring financial risk tolerance, and particularly measuring financial risk tolerance, in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carries out in various ways. Also, it is to be understood that the phraseology and terminology employed herein are for the purpose of description and should not be regarded as limiting.

These, together with other objects of the invention, along with the various features of novelty, which characterize the invention, are pointed out with particularity in the claims annexed to and forming a part of this disclosure. For a better understanding of the interactive systems, apparatuses and accompany methods, the operating advantages and the specific objects attained by usage, reference should be made to the accompanying drawings and descriptive matter in which there are illustrated preferred embodiments of the invention.

### BRIEF DESCRIPTION OF THE DRAWINGS

The invention may be more completely understood in consideration of the following detailed description of the various embodiments of the invention in connection with the accompanying drawings, in which:

FIG. 1A is a schematic diagram of an exemplary embodiment of a computer system.

FIG. 1B illustrates a schematic representation of a system for using financial risk tolerance analysis to determine a user's financial risk tolerance.

FIG. 2 illustrates a block diagram of a method for assessing a user's financial risk tolerance.

FIG. 3 illustrates a block diagram of a system to gather a user's financial information to be used in determining a user's financial risk tolerance.

FIGS. 4A-C illustrates a block diagram of a system to determine a user's financial risk tolerance.

FIGS. 5A-10 illustrate exemplary web interfaces to be used to gather a user's financial information.

FIGS. 11-17 illustrate exemplary web interfaces for a welcome tutorial for new users to determine their financial risk tolerance.

FIGS. 18-20 and 21A-21D illustrate an exemplary web interfaces to determine a user's financial risk assessment.

FIG. 22 illustrates an embodiment of an advertising system.

### DETAILED DESCRIPTION OF THE SEVERAL EMBODIMENTS

For the following defined terms, these definitions shall be applied, unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following description should be read with reference to the drawings wherein like reference numerals indicate like elements throughout the several views. The drawings, which are not necessarily to scale, depict illustrative embodiments of the claimed invention.

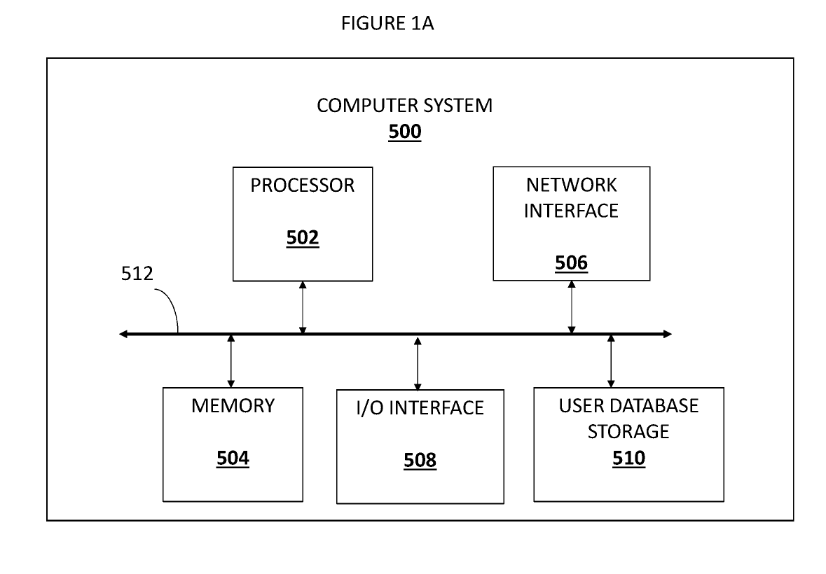

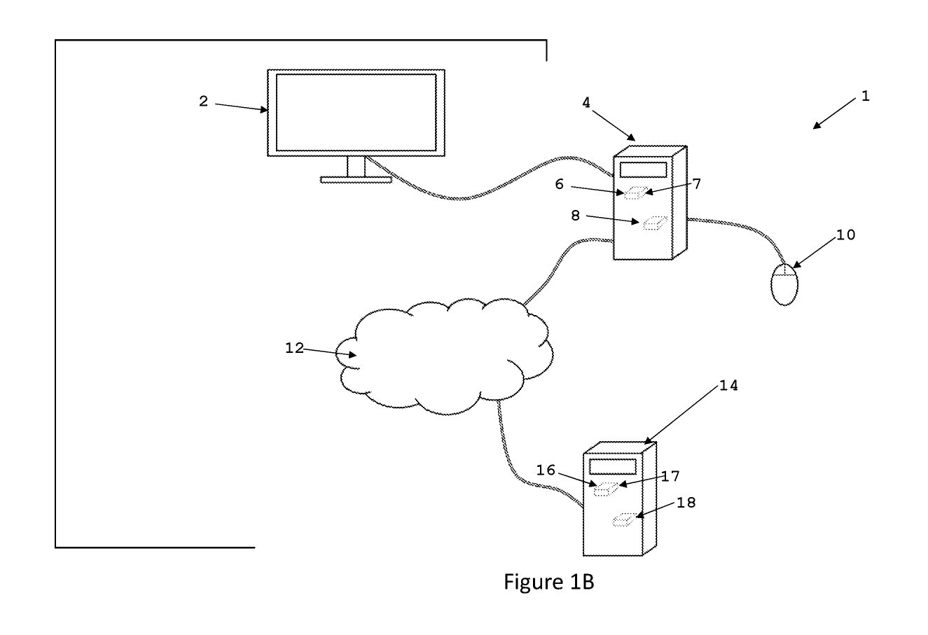

FIG. 1A is a schematic diagram of one exemplary embodiment of a computer system. Herein, the systems and methods disclosed can be implemented using one or more computer systems, such as the exemplary embodiment of a computer system 500 shown in FIG. 1A. As shown, the computer system 500 can include one or more processors 502 which can control the operation of the computer system 500. The processor(s) 502 can include any type of microprocessor or central processing unit (CPU), including programmable general-purpose or special-purpose microprocessors and/or any one of a variety of proprietary or commercially available single or multi-processor systems. The computer system 500 can also include one or more memories 504, which can provide temporary storage for code to be executed by the processor(s) 502 or for data acquired from one or more users, storage devices, and/or databases. The memory 504 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies. The various elements of the computer system 500 can be coupled to a bus system. The bus system can be any one or more separate physical busses, communication lines/interfaces, and/or multi-drop or point-to-point connections, connected by appropriate bridges, adapters, and/or controllers. The computer system 500 can also include one or more network interface(s) 506, one or more input/output (IO) interface(s) 508, and one or more storage device(s) 510. The network interface(s) 506 can enable the computer system 500 to communicate with remote devices (e.g., other computer systems) over a network, and can be, for example, remote desktop connection interfaces, Ethernet adapters, and/or other local area network (LAN) adapters. The IO interface(s) 508 can include one or more interface components to connect the computer system 500 with other electronic equipment. For example, the IO interface(s) 508 can include high speed data ports, such as USB ports, 1394 ports, etc. Additionally, the computer system 500 can be accessible to a human user, and thus the IO interface(s) 508 can include displays, speakers, keyboards, pointing devices, and/or various other video, audio, or alphanumeric interfaces. The storage device(s) 510 can include any conventional medium for storing data in a non-volatile and/or non-transient manner. The storage device(s) 510 can thus hold data and/or instructions in a persistent state (i.e., the value is retained despite interruption of power to the computer system 500). The storage device(s) 510 can include one or more hard disk drives, flash drives, USB drives, optical drives, various media cards, and/or any combination thereof and can be directly connected to the computer system 500 or remotely connected thereto, such as over a network. The elements illustrated in FIG. 1a can be some or all of the elements of a single physical machine. In addition, not all of the illustrated elements need to be located on or in the same physical or logical machine. Rather, the illustrated elements can be distributed in nature, e.g., using a server farm or cloud-based technology. Exemplary computer systems include conventional desktop computers, workstations, minicomputers, laptop computers, tablet computers, PDAs, mobile phones, and the like. Although an exemplary computer system is depicted and described herein, it will be appreciated that this is for sake of generality and convenience. In other embodiments, the computer system may differ in architecture and operation from that shown and described here.

FIG. 1B illustrates a system 1 used to measure financial risk tolerance. By way of non-limiting example, the systems and methods disclosed herein can be implemented by the exemplary system 1. In this embodiment, the system includes a display 2, a computer 4, and an input device 10 such as a mouse or a keyboard. The computer 4 may be connected to a local or distributed network 12, such as the internet. The computer 4 comprises a processing device 8 and computer readable memory 6, which may include at least one database 7. One skilled in the art should understand that computer readable memory 6 can be, for example, random access memory, a hard drive, a flash drive, a CD-ROM, a DVD or a combination thereof. The system 1 may also comprise other computers 4 connected to the internet 12 such as a server 14 which may include its own processor 16 and computer readable memory 18, which may include at least one database 17. In this embodiment of the system, a program or program code is stored on computer readable memory 6, on one or more computer 4 or server 14 connected to the network 12.

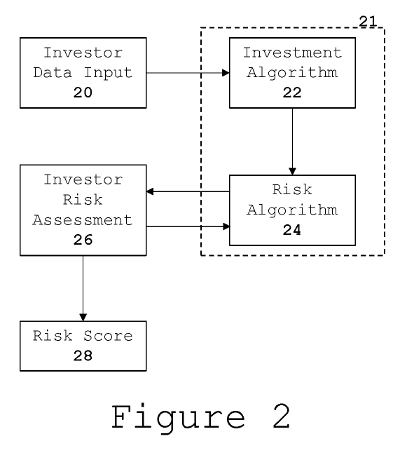

FIG. 2 illustrates one embodiment of a method of assessing an investor's financial risk tolerance. At step 20, the investor initially inputs data into the system. At step 22, the data is stored in the system and applied to an algorithm to determine the performance of the investor's assets. At step 24, the input data is then applied to a risk algorithm, which generates hypothetical scenarios based on varying levels of risk. Steps 22, the investment algorithm, and 24, risk algorithm, are run by the system backend 21. At step 26, the investor then assesses the risk scenarios to determine what level of risk they are comfortable with in their investments. Then, at step 28, a risk score is generated based on the investor's risk assessments 28.

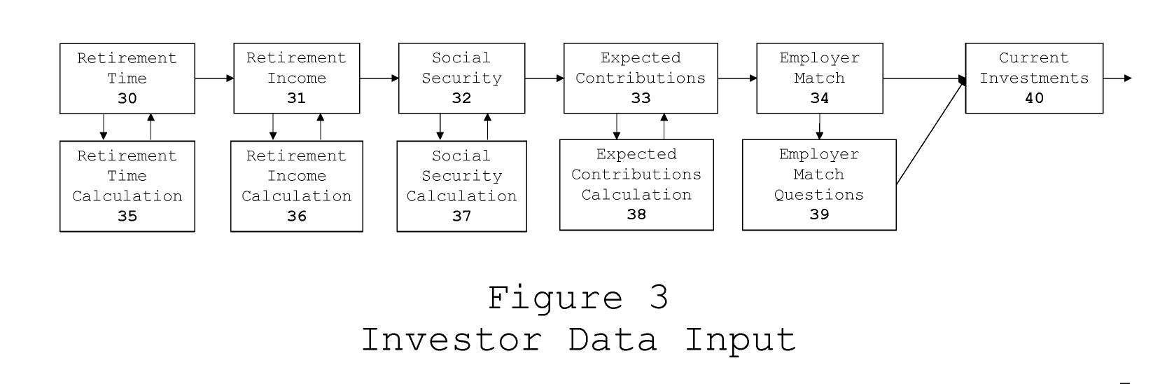

FIG. 3 illustrates an embodiment of the method of gathering investor data. The information is gathered about the investor's retirement plans. In this embodiment of the method, at step 30, the information gathered includes the time that the investor would like to retire, then, at step 31, the investor's expected retirement income is gathered, then, at step 32 the investor's social security information is recorded, then, at step 33, information about the investor's expected contributions to their retirement fund is collected, then at step 34 the investor's employer's match data is collected and finally, at step 40, information about the investor's current investments is gathered. In a further embodiment of the invention, at step 35, the investor has the option to be assisted in calculations relating to the time that the investor would like to retire. At step 36, the investor has the option to be assisted in calculations relating to the investor's expected retirement income. At step 37, the investor has the option to be assisted in calculations relating to the investor's social security information. Then, at step 38, the investor has the option to be assisted in calculations relating to the investor's expected contributions to their retirement fund. At step 39, if an investor's employers match the investor's expected contributions, the investor will then be directed to answer further questions.

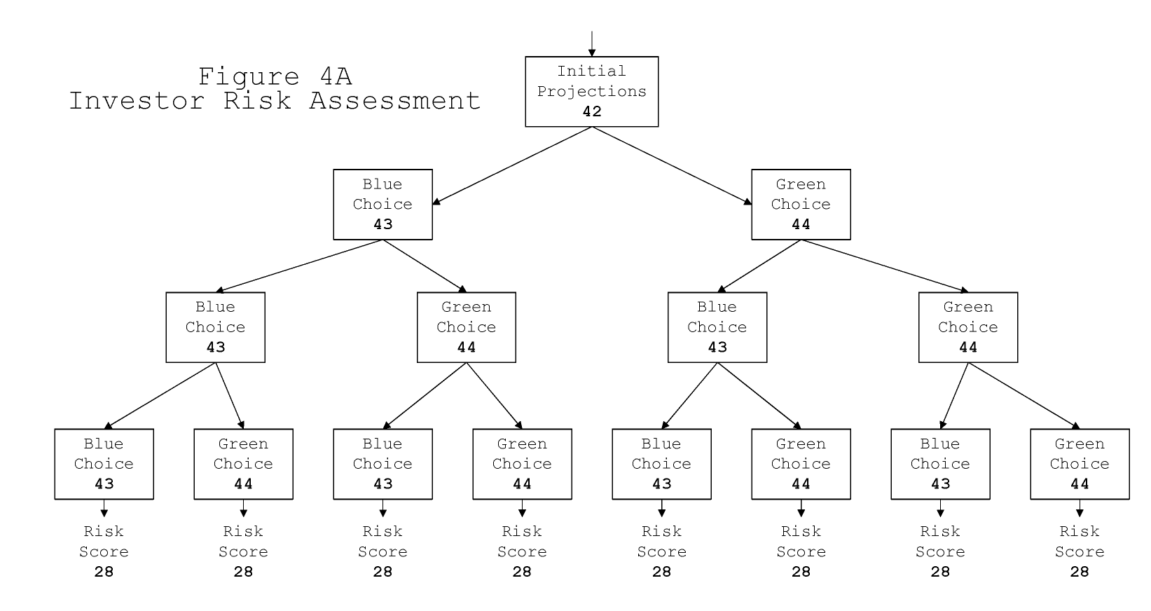

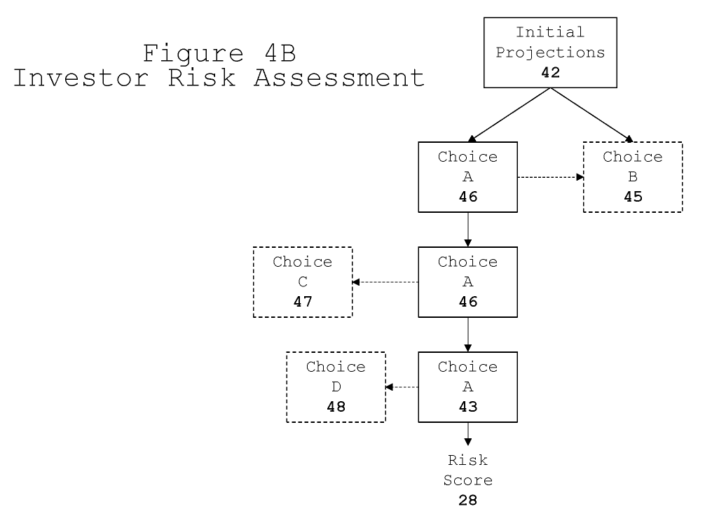

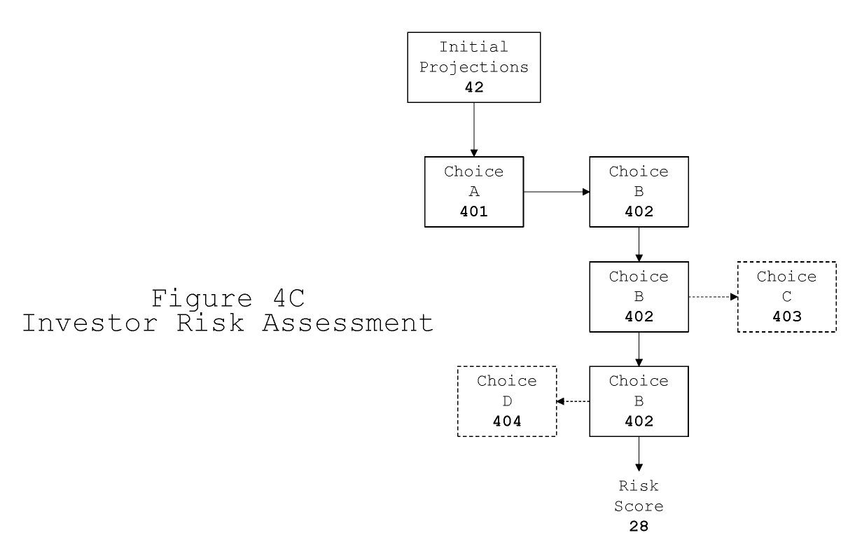

FIG. 4A illustrates a method for assessing the financial risk tolerance of an investor. At step 42, initial projections are made using the data input by the investor. The investor is then presented with two choices. At step 43, the investor is presented with a blue choice. At step 44, the investor is presented with a green choice. In this embodiment of the invention the green choice is a more aggressive or riskier choice and the blue choice is a more conservative choice, however in other embodiments the blue choice may be the riskier choice and the green choice may be the more conservative choice. After each choice the backend 21 (See FIG. 2) generates either a riskier or less risky portfolio for the user to compare the portfolio they previously selected. In this embodiment of the invention, the investor chooses a scenario three times before receiving their risk score, however in other embodiments of the invention the user may be asked to choose between multiple scenarios a plurality of times. Once the investor has made the predetermined number of choices, at step 28, the investor is assigned a risk score based on their selections.

FIG. 4B illustrates an exemplary embodiment of the invention where the user is presented with two choices. At step 42, initial projections are made using the data input by the investor. At step 46, Choice A is the option and at step 45 Choice B is the option. Choice A at step 46 is a portfolio of with a predetermined amount of risk. In this embodiment of the invention Choice B 45 is a portfolio with more risk than Choice A at step 46, however in other embodiments Choice B at step 45 may have less risk than Choice A at step 46. The amount of risk associated with Choice A at step 46 or Choice B at step 45 is not disclosed to the user. The user decides which portfolio they are more comfortable with. In this example the user has chosen Choice A at step 46. The backend 21 generates another portfolio that is either riskier or less risky than the portfolio the user previously selected. The user is then presented with the new portfolio, Choice C, at step 47. Since the user previously selected the option with less risk, the backend 21 generated a new Choice that is less risky than Choice A at step 45. The amount of risk associated with Choice A at step 45 or Choice C at step 47 is not disclosed to the user. In this example the user chooses Choice A at step 45 again. The user is then presented with a fourth portfolio, Choice D, at step 48. With the purpose of generating a portfolio that is closer to the user's true risk tolerance Choice D at step 48 is created more risky than Choice A at step 45 but less risky than Choice B at step 46. The amount of risk associated with Choice A at step 45 or Choice D at step 48 is not disclosed to the user. In this example the user chooses Choice A at step 45 again. By delineating the boundaries of the user's risk tolerance the user's risk is quantified into a risk score at step 28.

FIG. 4C illustrates an exemplary embodiment of the invention where the user is presented with two choices. At step 42, initial projections are made using the data input by the investor. Choice A is presented at step 401. Choice B is presented at step 402. Choice A at step 401 is a portfolio with a predetermined amount of risk. The backend 21 generates Choice B at step 402 to compare with Choice A at step 401. In this embodiment of the invention Choice B at step 402 is a portfolio with more risk than Choice A at step 401, however in other embodiments Choice B 402 may have less risk than Choice A 401. The amount of risk associated with Choice A 401 or Choice B 402 is not disclosed to the user. The user decides which portfolio they are more comfortable with. In this example the user has chosen Choice B at step 402. The backend 21 generates Choice C at step 403 to be compared with the portfolio that the user previously selected. The user is then presented a new portfolio, Choice C at step 403. Since the user previously selected the option with more risk, the backend generated a portfolio that is more risky than Choice B at step 402. The amount of risk associated with Choice B at step 402 or Choice C 403 is not disclosed to the user. In this example the user chooses Choice B at step 402 again. The backend 21 then generates Choice D at step 404 to be compared with the portfolio that the user previously chose. The user is then presented with a fourth portfolio, Choice D at step 404. In this embodiment the backend generated Choice D at step 404 is less risky than Choice B at step 402 but more risky than Choice A at step 401. The amount of risk associated with Choice B at step 402 or Choice D at step 404 is not disclosed to the user. In this example the user chooses Choice B 4602 again. By delineating the boundaries of the user's risk tolerance the user's risk is quantified into a risk score at step 28.

The processes and methods illustrated in FIGS. 4A-C may be repeated a plurality of time to generate a more accurate risk score.

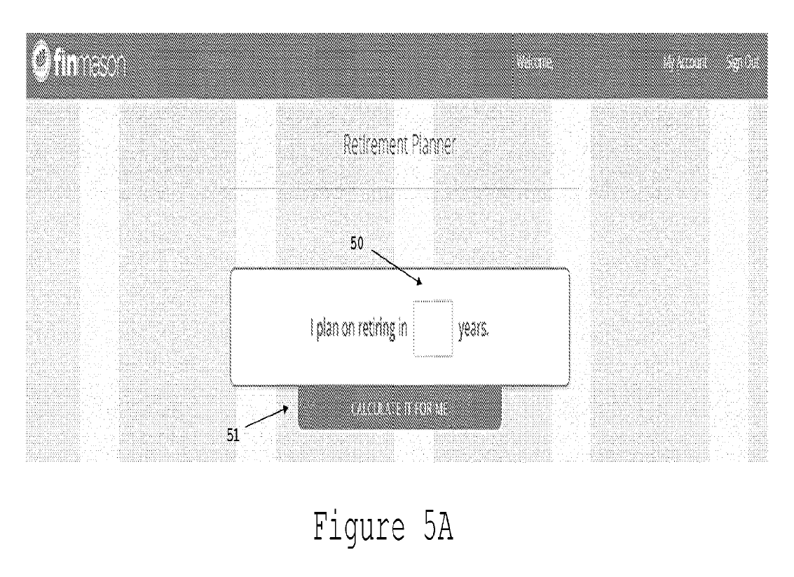

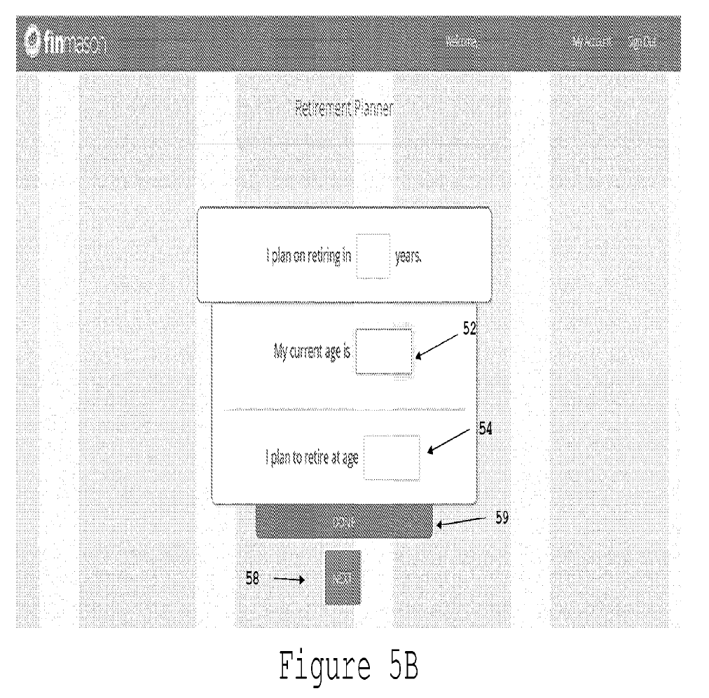

FIG. 5A illustrates an embodiment of a website application of the invention. When the investor logs into the system they are prompted to determine how long it will be until they retire. The investor fills in the retirement data at step 50. If the user does not know how long they would like to wait until retirement or they would like the system to calculate how long it will be until they retire they can elect to enter the age that they would like to retire at and their current age into a prompt which then using that information to calculate how long it will be until they retire with the retirement calculation button 51.

FIG. 5B illustrates the retirement calculation application. If an investor elects to have his retirement time calculated, he is prompted to enter his current age 52 and the age they wish to retire at 54. Once they have entered that information the length of time until they retire is calculated once they press the retirement calculator done button 59. Once all of the information has been inputted the user continues by pressing the next button 58.

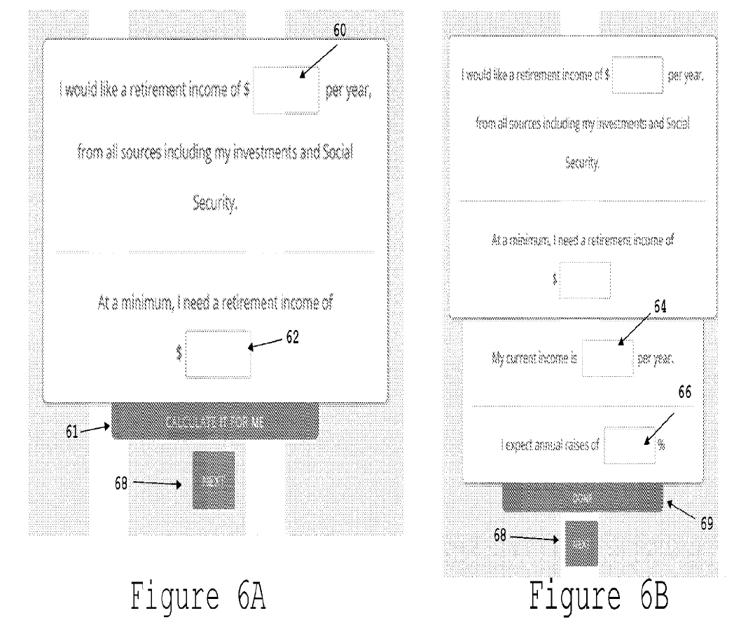

FIG. 6A illustrates an embodiment of the retirement income data collection module displayed at step 31. The investor is prompted to input the retirement income he would like to have per year 60 and the minimum amount of income he would need during retirement 62. If the user does not know how much income they want or need during retirement or they would like the system to calculate they can choose to have that information calculated for them with the retirement income calculation button 61.

FIG. 6B illustrates an embodiment of the retirement income calculation tool as shown at step 36. The investor is prompted to enter his current income 64 and their expected annual raise percentage 66. The investor's retirement income data is calculated when the user pushed the retirement income calculation done button 69. Once the investor's data has been entered pressing the retirement income next button 68 advances them to the next data collection module.

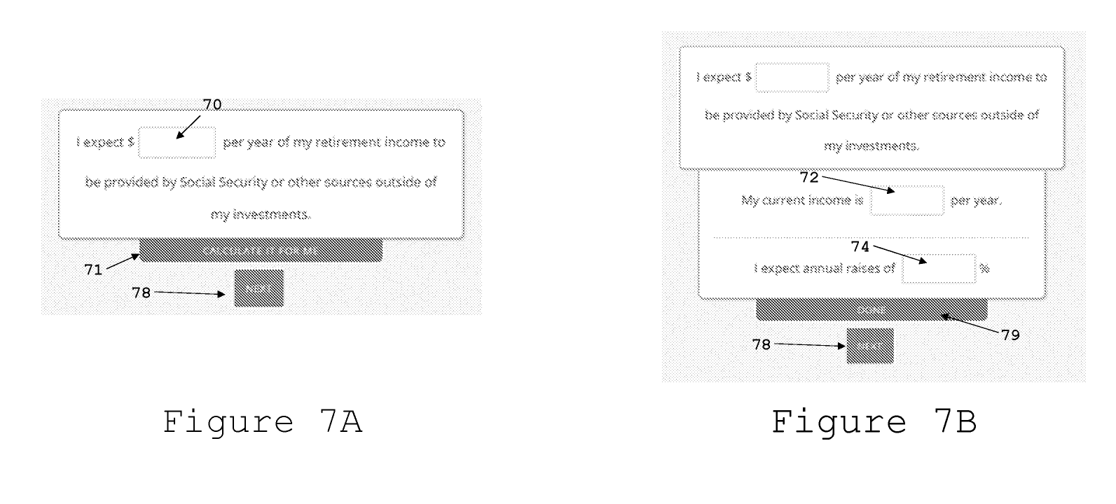

FIG. 7A illustrates an embodiment of the social security module presented at step 32. The user is prompted to input how much of their income they expect to be provided by social security 70. If the user does not know how much income they will receive from social security or they would like the system to calculate it they can choose to have that information calculated for them with the social security calculation button 71.

FIG. 7B illustrates an embodiment of the social security calculation tool presented at step 37. The investor is prompted to enter their current income 72 and their expected annual raise percentage 74. The investor's social security data is calculated when the user pushed the social security calculation done button 79. Once the investor's data has been entered pressing the social security next button 78 advances them to the next data collection module.

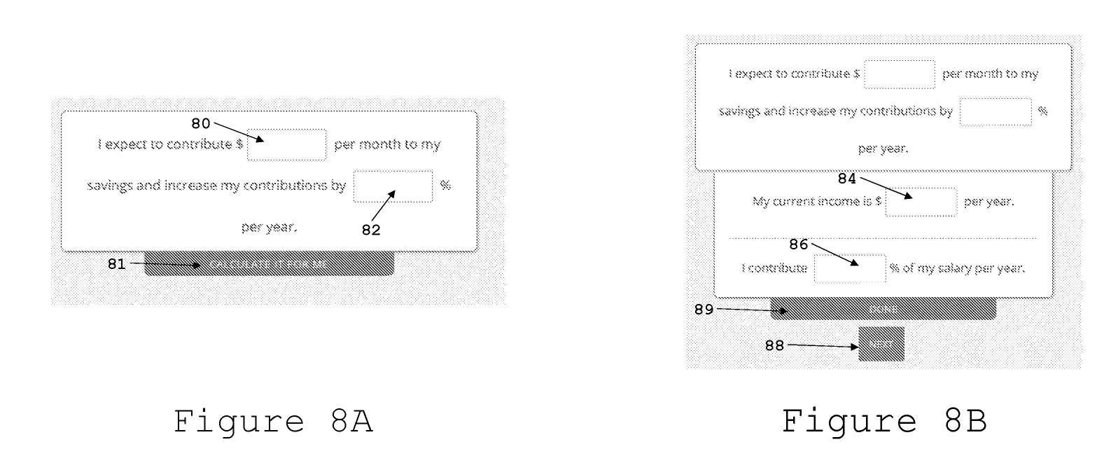

FIG. 8A illustrates an embodiment of the expected contribution module presented at step 33. The user is prompted to input how much they expect to contribute to their savings 80 and what percentage they plan to increase that annually 82. If the user does not know how much they expect to contribute or they would like the system to calculate it they can choose to have that information calculated for them with the expected contribution calculation button 81.

FIG. 8B illustrates an embodiment of the expected contribution calculation tool presented at step 38. The investor is prompted to enter their current income 84 and their expected annual raise percentage 86. The investor's expected contribution data is calculated when the user pushed the expected contribution calculation done button 89. Once the investor's data has been entered pressing the expected contribution next button 88 advances them to the next data collection module.

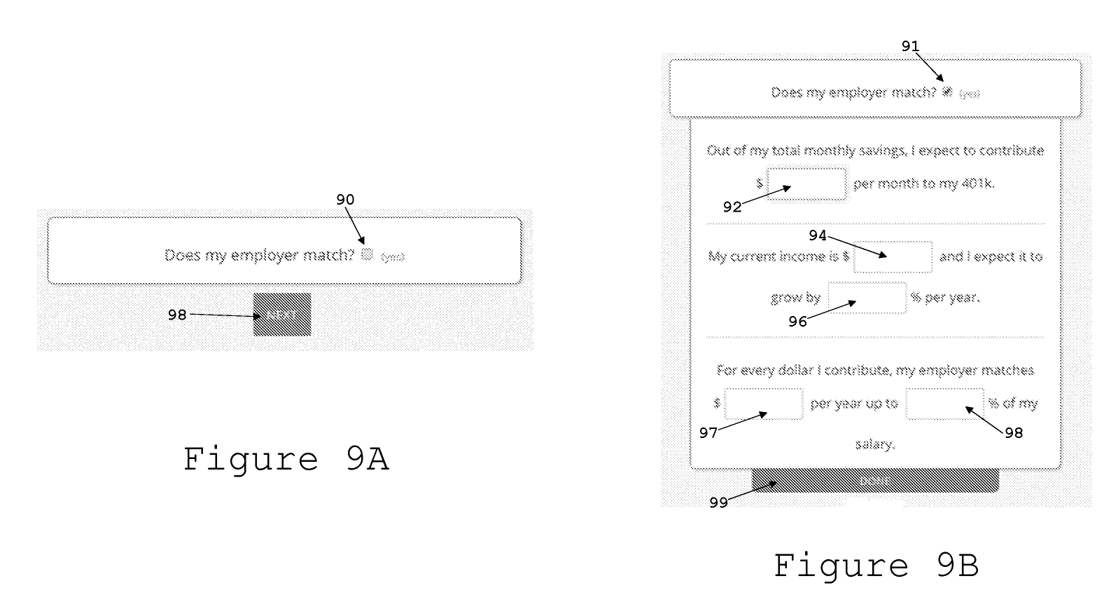

FIG. 9A illustrates an embodiment of the employer match module presented at step 34. The user is prompted to input whether their employer matches 90. If the investor's employer does match the investor will be prompted to answer further questions.

FIG. 9B illustrates an embodiment of the further questions if the employer matches module presented at step 39. The investor is prompted to enter the amount he currently contributes to his 401k 92, his current income 94, the amount he expect his income to grow annually 96, the amount that the investor's employer matches 97 and the percent of the investor's salary that his employer is willing to match 98. The investor's employer's match data is calculated when the user pushed the employer match calculation done button 99. Once the investor's data has been entered pressing the employer match next button 98 advances them to the next data collection module.

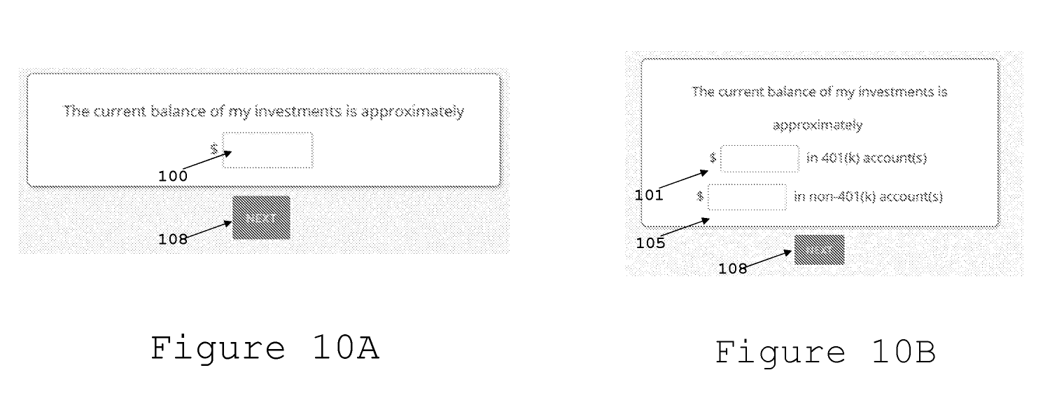

FIG. 10A illustrates an embodiment of the current investments module presented at step 40. The user is prompted to enter the value of their current investments 100. Once the investor's data has been entered pressing the current investments next button 108 advances them to the next module. If the investor is unsure what the current balance of his investments are, he may be promoted to a calculator as shown in FIG. 10B, wherein he is prompted to enter the value of his current 401(k) account 101 and the value of any non-401(k) accounts 105. Once the investor's data has been entered pressing the current investments next button 108 advances them to the next module.

FIG. 11 illustrates an embodiment of a tour of the risk measurement system. The first time an investor uses the system they are automatically brought to the tour. The initial tour screen 110 explains that the investor will be shown several scenarios to choose from. The scenario returns 103 are presented and compared to each other in a strong 104, normal 106, weak 107, and crash 109 markets. Clicking the next button 118 advances the investor to the next tour module.

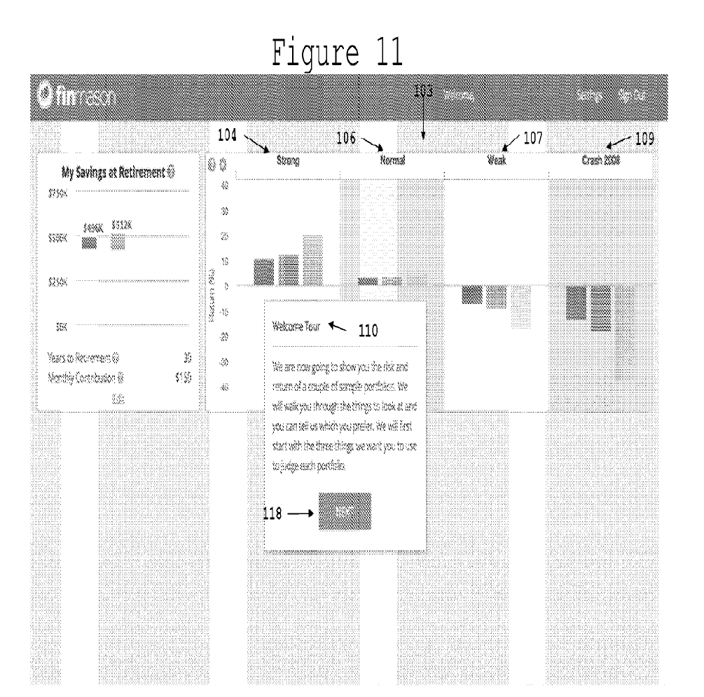

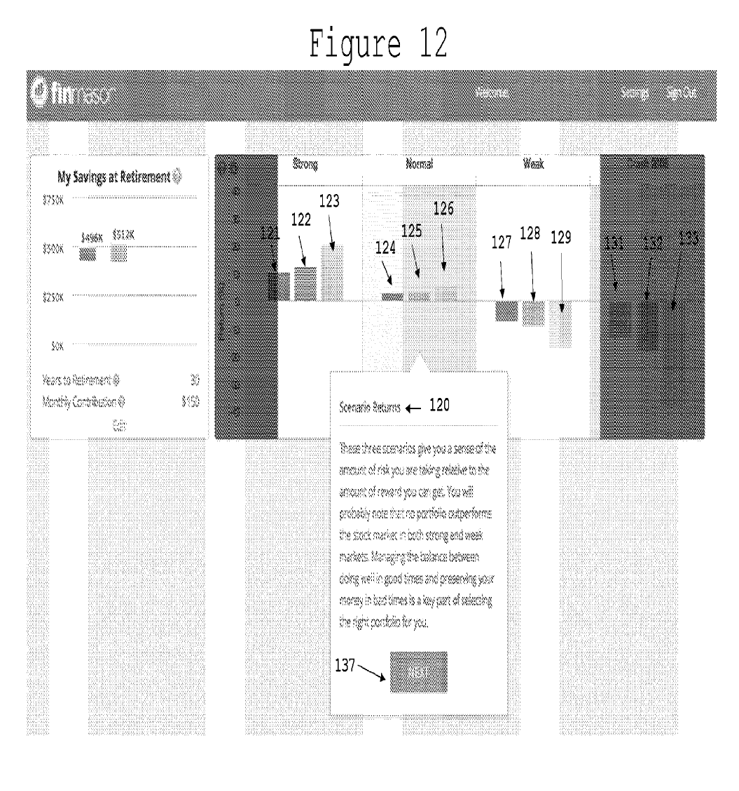

FIG. 12 illustrates an embodiment of the tour wherein the scenario returns 103 are explained 120. A blue choice scenario is shown for a strong market 121, a normal market 124, a weak market 127, and a crash market 131; a green choice scenario is shown for a strong market 122, a normal market 125, a weak market 128, and crash market 132, and the market performance is shown for a strong market 123, a normal market 126, a weak market 129, and a crash 133 market. Clicking the next button 137 advances the investor to the next tour module.

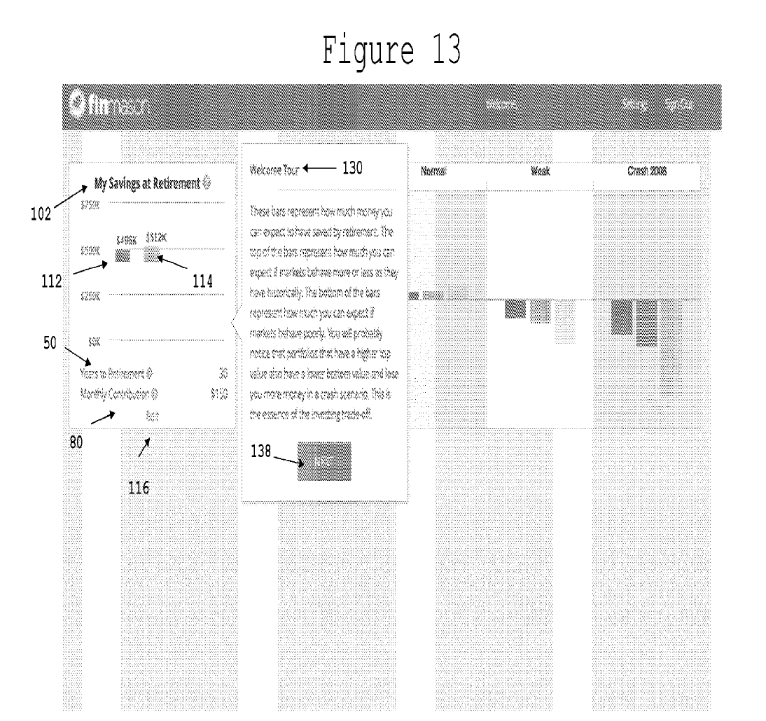

FIG. 13 illustrates an embodiment of the tour wherein the expected savings 102 are explained 130. A first choice bar or blue choice bar 112 indicates the expected range of return if the investor makes a blue choice and a second choice bar or green choice bar 114 indicates the expected range of return if the investor makes a green choice. In this embodiment of the system, the expected return module 102 indicates how many years until the user reaches retirement 50 and the investor's monthly contribution 80 to their retirement savings. An investor is always capable of editing 116 this information if need be. Clicking the next button 138 advances the investor to the next tour module.

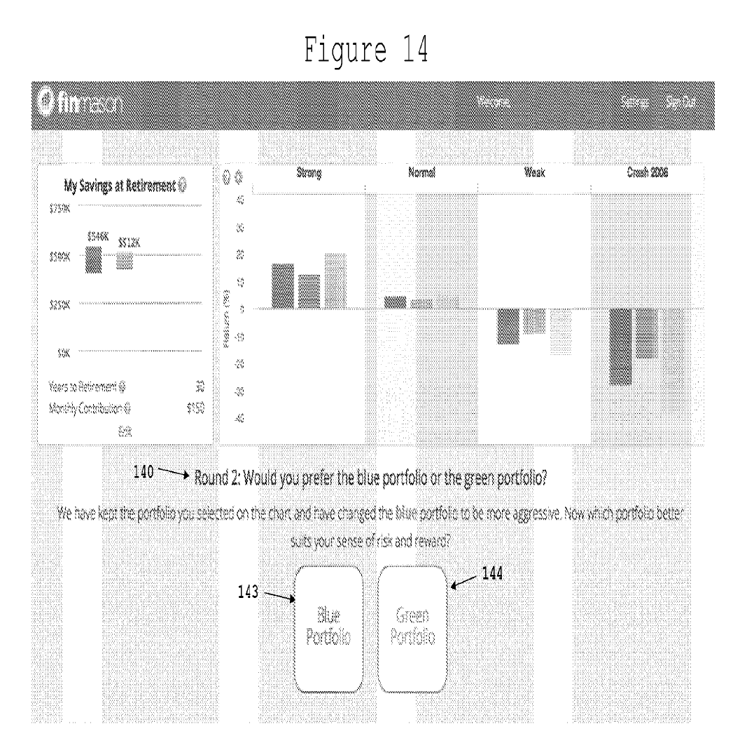

FIG. 14 illustrates an embodiment of the tour wherein the risk measurement method 140 is explained. In this module the blue portfolio 143 and green portfolio 144 are explained. The tour shows the investor an example wherein the investor chooses which example portfolio they are more comfortable with. In this embodiment the blue portfolio 143 is riskier that the green portfolio 144.

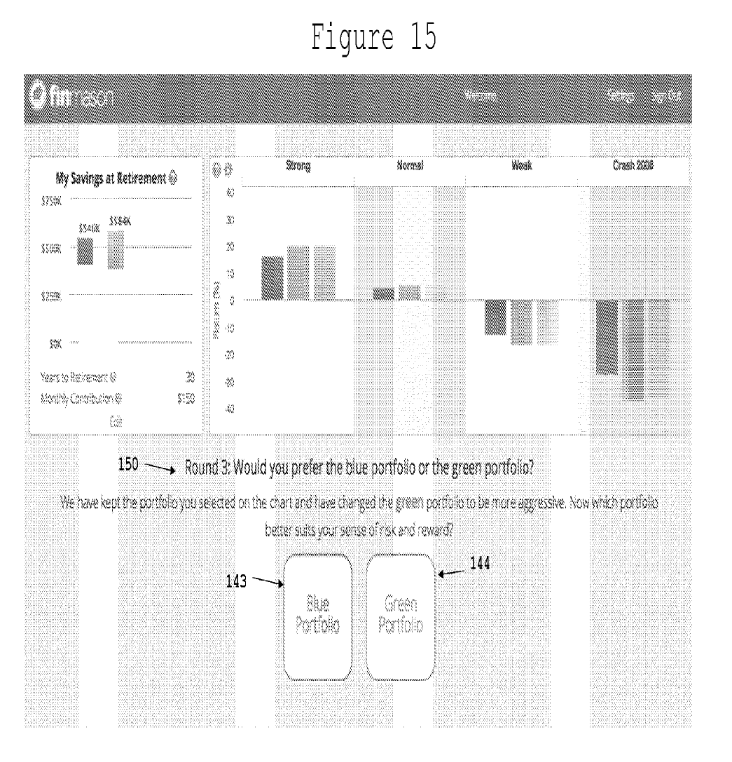

FIG. 15 illustrates an additional embodiment of the tour wherein the investor is shown an example third round 150 of the risk measurement system. The blue portfolio 143 was selected in the previous round and has been kept in round 3. A new green portfolio 144 has been added to be compared against the previous portfolio 143. In this embodiment the new portfolio 144 is more aggressive than the previous portfolio 143, however in other embodiments the new portfolio may be less aggressive than the previous portfolio 143.

FIG. 16 illustrates an embodiment of the tour wherein the results of a financial risk tolerance test are displayed 166. The target savings 161 and minimum savings 163 are indicated on the expected return module. During and after the test the investor can alter the values that affect the target savings 161 and minimum savings 163. A risk tolerance score 160 is displayed based on the investor's choices. The risk tolerance score 160 is used to determine that investor's risk classification 162. The portfolio 164 that the investor chose is displayed.

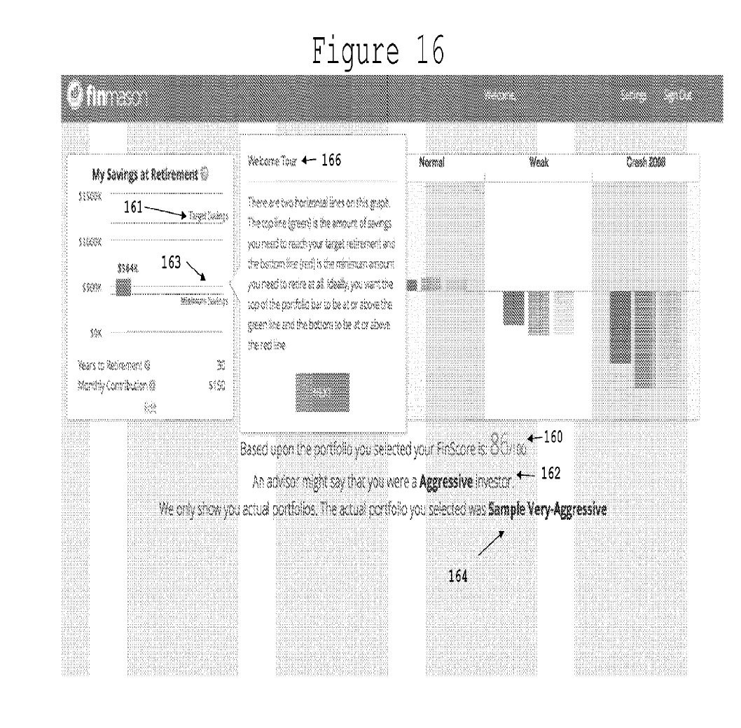

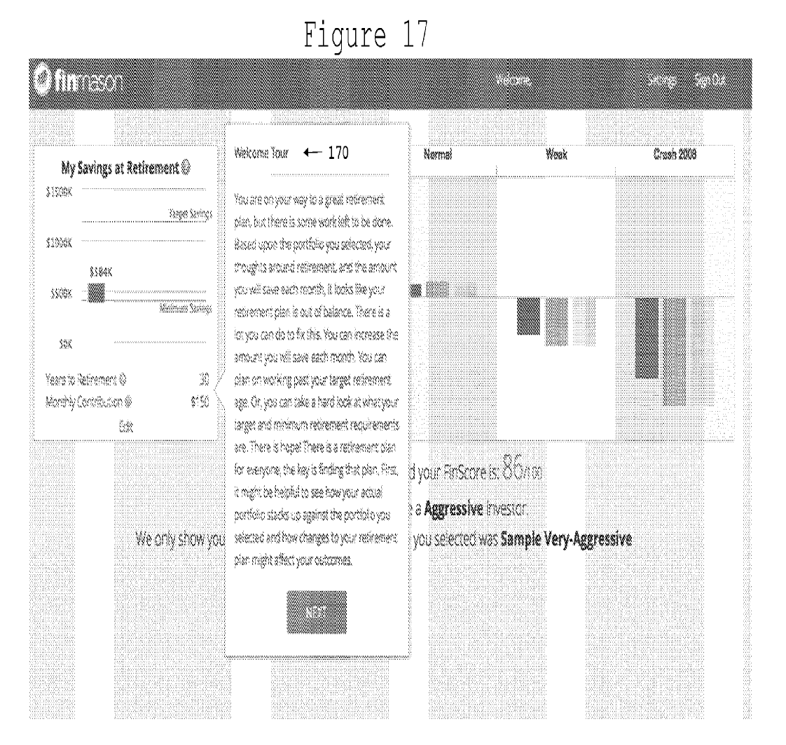

FIG. 17 illustrates an embodiment of the final screen 170 of the tour.

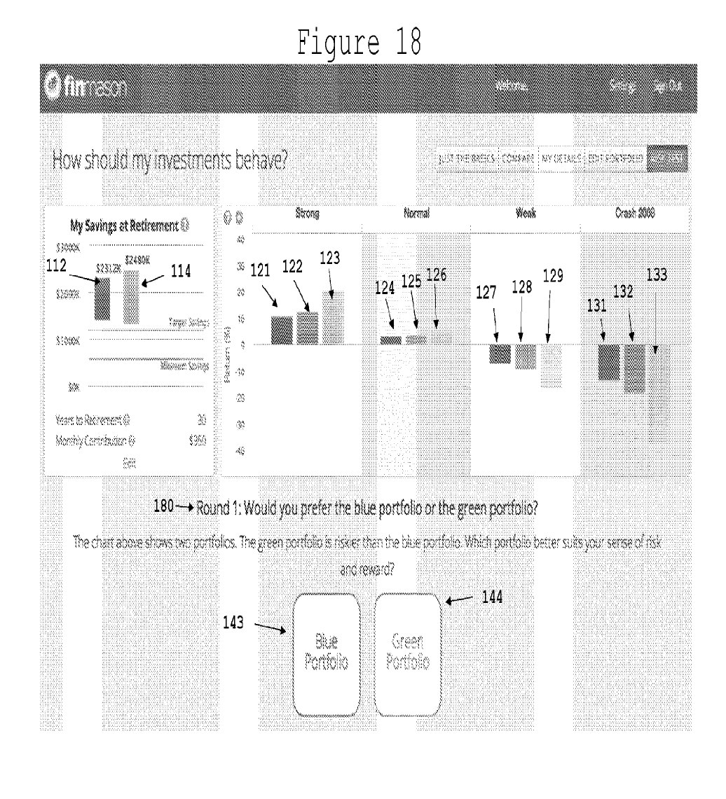

FIG. 18 illustrates an embodiment of round 1 180 of a financial risk tolerance test. In this embodiment of the invention the application generates two risk options, a blue option and a green option, however in other embodiments the invention may generate a plurality of options. A blue portfolio 143 and a green portfolio 144 are shown in comparison with each other and the stock market in strong 121 122 123, normal 124 125 126, weak 127 128 129, and crash 131 132 133 markets. They are also shown compared against each other in reference to the data input by the investor 112, 114. In this embodiment of the invention the user makes a single risk selection, however in other embodiments they may make a plurality of risk selections. The investor chooses which portfolio they are more comfortable with.

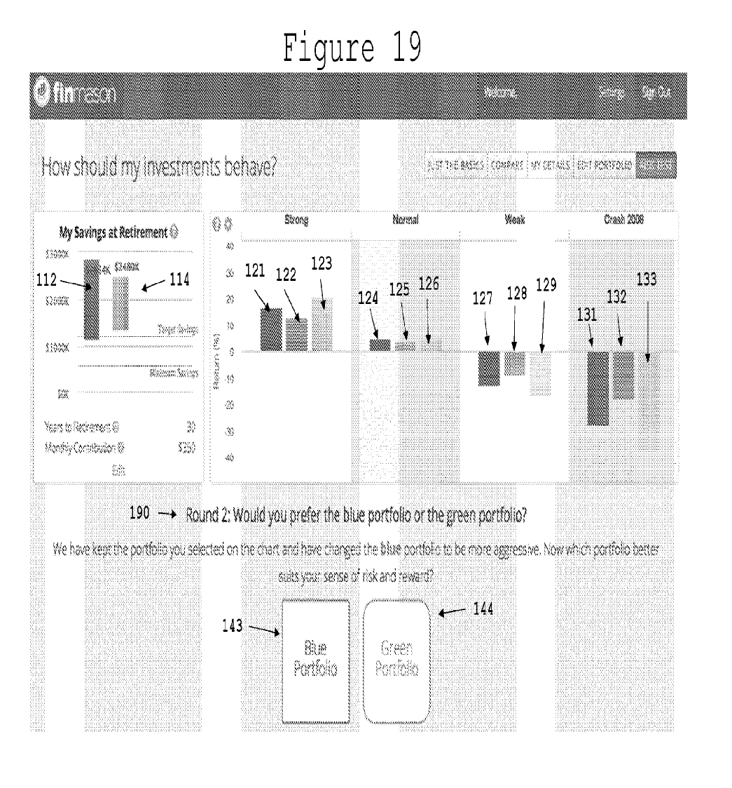

FIG. 19 illustrates an embodiment of round 2 190 of a financial risk tolerance test. In this example the blue portfolio 143 was chosen in round 1 180. The portfolio chosen in round 1 180 is kept and a new portfolio is added to compare against the previously selected portfolio. In this example the green portfolio 144 is new. The blue portfolio 143 and a green portfolio 144 are shown in comparison with each other and the stock market in strong 121, 122, 123, normal 124, 125, 126, weak 127, 128, 129, and crash 131, 132, 133, markets. They are also shown compared against each other in reference to the data input by the investor 112, 114. The investor chooses which portfolio they are more comfortable with.

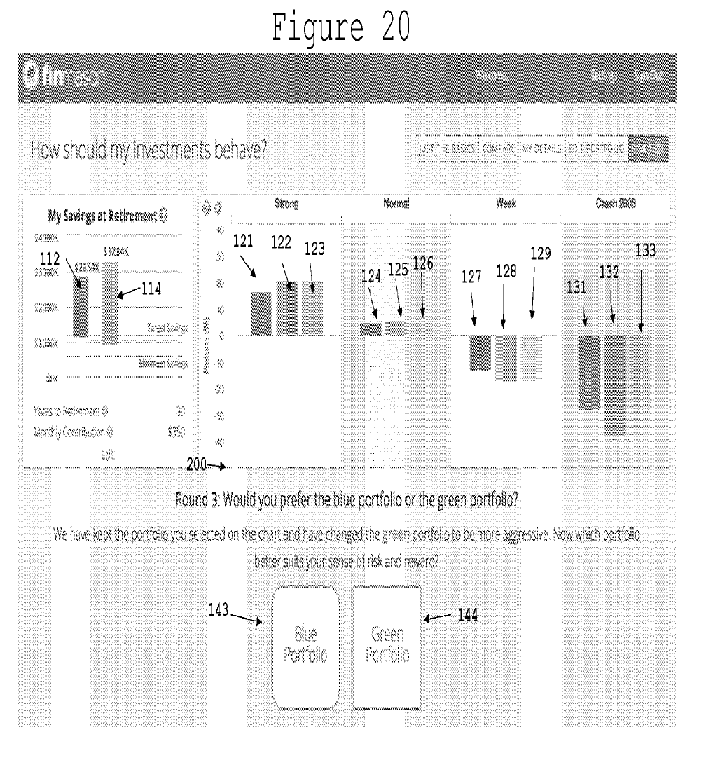

FIG. 20 illustrates an embodiment of round 32 200 of a financial risk tolerance test. In this example the green portfolio 144 was chosen in round 2 190. The portfolio chosen in round 2 190 is kept and a new portfolio is added to compare against the previously selected portfolio. In this example the blue portfolio 143 is new. The blue portfolio 143 and a green portfolio 144 are shown in comparison with each other and the stock market in strong 121, 122, 123, normal 124, 125, 126, weak 127, 128, 129, and crash 131, 132, 133, markets. They are also shown compared against each other in reference to the data input by the investor 112, 114. The investor chooses which portfolio they are more comfortable with.

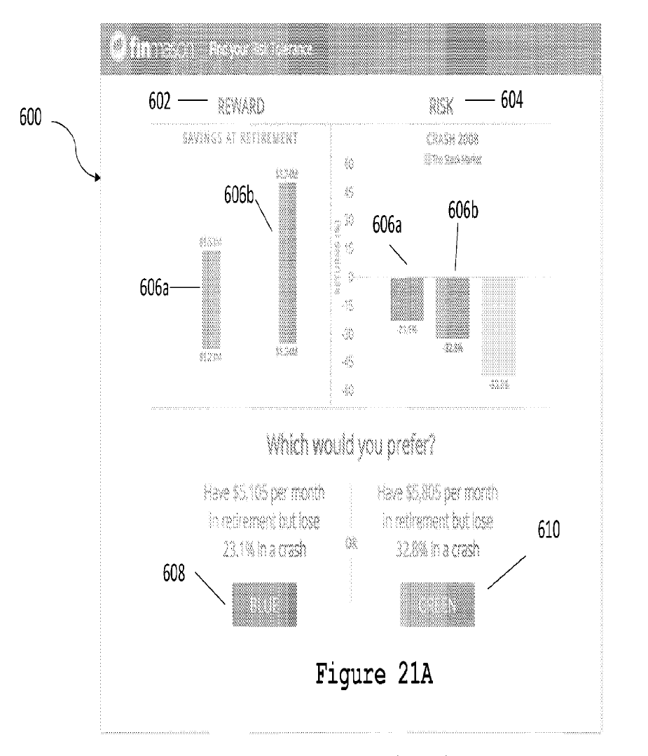

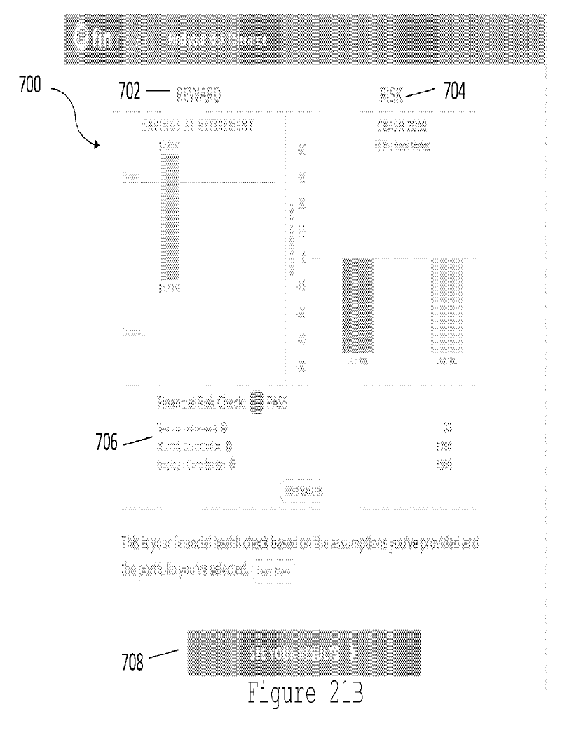

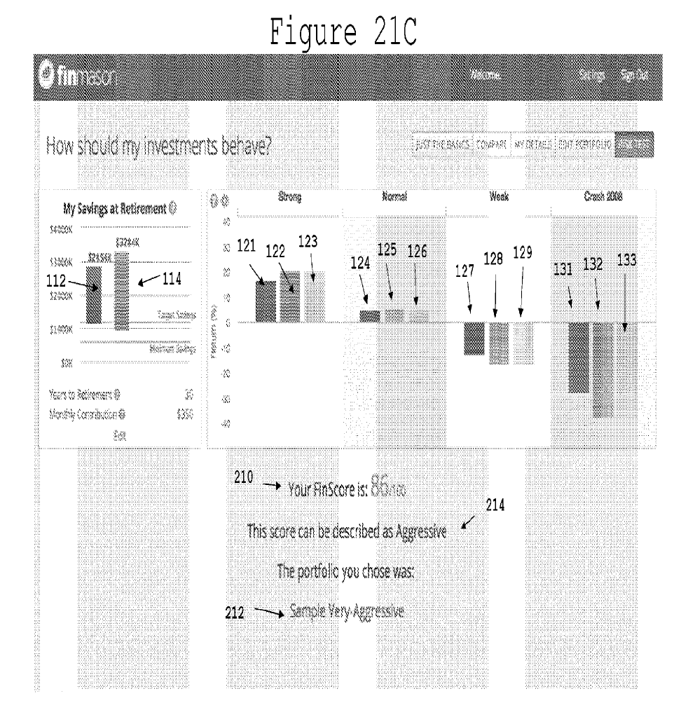

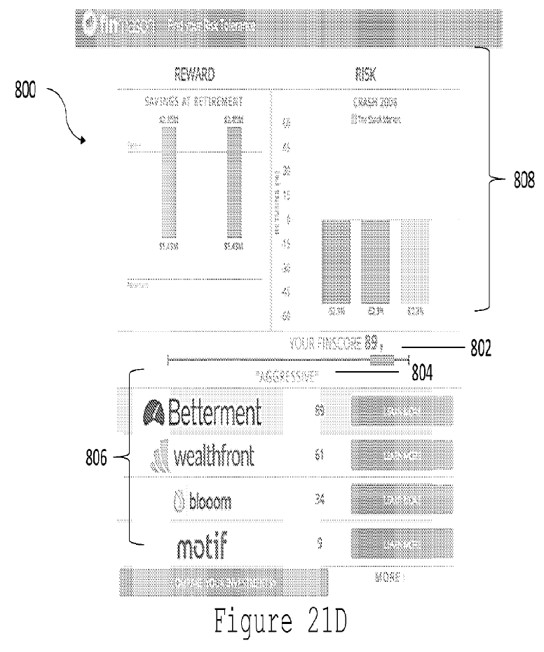

FIG. 21A illustrates an embodiment of any numbered round of a financial risk tolerance test 600. In this embodiment a reward section 602 is compared to a risk section 604. In each section, at least one portfolio option 606a is shown in comparison with another portfolio option 606b through the use of bar graphs in order to clearly display to a user the reward versus risk factors of each portfolio option. In this example, a blue portfolio 608 and a green portfolio 610 are shown in comparison with other. These portfolio options are determined based on the data input by the investor. Each portfolio option presented to the investor clearly relays to the investor the reward versus the risks of each individual portfolio. Herein, the investor is asked which portfolio, the blue portfolio 608 or the green portfolio 610, he/she prefers. Further herein, in this example specifically, the investor is clearly shown that if he/she chooses the blue portfolio 608, he/she would have $5,105.00 per month but lose 23.1% in a stock market crash situation. Whereas, if the investor chooses the green portfolio 610, he/she would have $5,805.00 per month but lose 32.8% in a stockmarket crash situation. The investor chooses which portfolio they are more comfortable with.

FIG. 21B illustrates an embodiment of a financial health check 700. The financial health check is based on the assumptions the user/investor provided in the previous financial risk assessments and also based on the portfolio the investor ultimately chose. In this example, the investor is shown a rewards section 702 versus a risk section 704 based on the portfolio he selected earlier. The investor is also shown a Financial Risk Check 706 which outlines the assumptions the investor chose through his assessments. For example, the investor may be shown how many years he has left until retirement, his personal monthly contribution, and his employer's monthly contribution. These values may be double checked by the user and edited before the user decides to move forward and view his results 708.

FIG. 21C illustrates an embodiment of the final portion of a financial risk tolerance system. The investor's risk score 210 is displayed. The risk score 210 is used to determine the investor's risk classification 214. The portfolio 212 that the investor chose is displayed.

In another embodiment of the invention the portfolios that the investor chooses from are actual investment portfolios, rather than hypothetical portfolios may be displayed.

In another embodiment of the system, factors used to determine target savings 161 and minimum savings 163 can be altered by the user to assess if their risk level is likely to result in a secure retirement plan (see FIG. 16).

FIG. 21D illustrates an additional embodiment of the final portion of a financial risk tolerance system 800. Herein, the investor's financial tolerance risk score or “Fin Score” 802 is displayed. The risk score is used to determine the investor's risk classification 804. Herein this example, the risk score is deemed to be “aggressive.” The portfolio that the investor chose is further displayed 808. Further, in this embodiment, a series of investment portfolios 806 is presented to the investor based on the investor's financial risk tolerance score, wherein the investor may choose to invest in a specific investment portfolio.

Furthermore, in an additional embodiment, a system configured to assess financial risk tolerance is presented where the system comprises of at least one processor, at least one memory, and a plurality of storage devices. The system for assessing financial risk tolerance when executed performs the steps of generating a set of financial parameters and/or questions to create an investor's financial tolerance. As explained above, these parameters may include questions regarding when an investor plans to retire, how much money he is investing into his 401(k) plan, etc. Upon the investor answering these parameters, the processor receives a set of investor data inputs in response to the financial parameters. If need be, as explained above, the program may assist the investor in calculating his investor data inputs. Based on the set of investor data inputs received by the processor, a financial valuation is determined and then a set of financial risk preferences is provided to the investor. The financial risk preferences are accessed by the investor and the investor selects appropriate responses based on their financial risk preferences. The processer receives this data, assesses the data based on the investor's selections and may provide a series of additional financial risk preferences. After the investor completes the series of selections, the processor then generates a financial risk tolerance score based on the financial risk preferences and corresponding user selections.

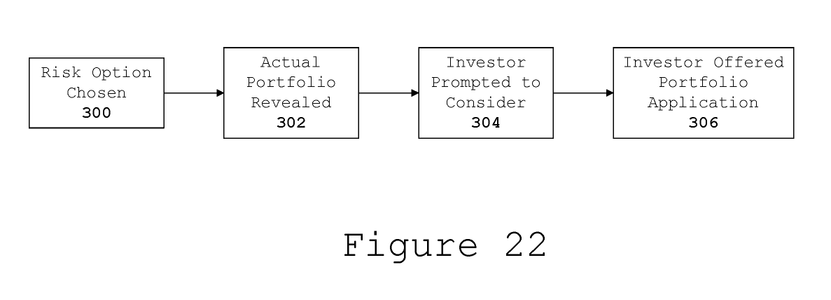

FIG. 22 illustrates an embodiment of an advertising system. At step 300, the investor chooses which portfolio he is most comfortable with. Then, at step 302, the name of the actual portfolio that they chose is revealed. This portfolio is an actual investment portfolio that the investor can choose to invest in. In this embodiment, at step 304 the investor is prompted to examine the portfolio they have chosen, however in other embodiments they may not be prompted to examine the portfolio. At step 306, the investor is then offered to apply for that portfolio they have chosen.

What is claimed is:

1. A system configured to assess financial risk tolerance, the system comprising:
a processor, a memory and a plurality of storage devices;
the system for assessing financial risk tolerance when executed performs the steps of:
generating a set of financial parameters to create a financial risk tolerance;
receiving a set of investor data inputs in response to the set of financial parameters;
determining a financial valuation based on the set of investor data inputs;
providing a set of financial risk preferences based on the set of investor data inputs;
receiving a set of corresponding user selections in response to the set of financial risk preferences;
assessing the set of corresponding user selections to provide another set of financial risk preferences;
generating a financial risk tolerance score based on a repeated plurality of financial risk preferences and corresponding user selections.

2. The system configured to assess financial risk tolerance of claim 1, further comprising:
receiving one or more sets of corresponding user selections to generate the financial risk tolerance score;
accessing the financial risk tolerance score to present an investor with at least one financial portfolio;
presenting to the investor the at least one financial portfolio;
prompting the investor to examine the at least one financial portfolio;
offering the investor to apply to the at least one financial portfolio.

3. The system configured to assess financial risk tolerance of claim 1, wherein the set of financial parameters to create the financial risk tolerance include a set of financial assessment questions.

4. The system configured to assess financial risk tolerance of claim 1, further comprising, generating a target savings of the user and the minimum savings of the user based on the set of corresponding user selections.

5. The system configured to assess financial risk tolerance of claim 1, further comprising creating a first portfolio option and a second portfolio option based on the set of corresponding user selections.

6. The system configured to assess financial risk tolerance of claim 1, further comprising analyzing the investor data inputs in a plurality of market scenarios.

7. The system configured to assess financial risk tolerance of claim 6, wherein the plurality of market scenarios are selected from a group consisting of a strong market, a normal market, and a crash market.

8. The system configured to assess financial risk tolerance of claim 1, further comprising, presenting at least one financial portfolio to choose from.

9. The system configured to assess financial risk tolerance of claim 1, wherein generating the financial risk tolerance score is further based on a financial risk tolerance scale.

10. The system configured to assess financial risk tolerance of claim 9, wherein the financial risk tolerance scale is selected from the group consisting of aggressive, moderate, and passive.

11. A method for assessing a financial risk tolerance of an investor using a system consisting of a processor connected to a database, comprising:
generating by the processor a set of financial parameters to create a financial risk tolerance;
receiving by the processor a set of investor data inputs in response to the set of financial parameters;
determining by the processor a financial valuation based on the set of investor data inputs;
providing by the processor a set of financial risk preferences based on the set of investor data inputs;
receiving by the processor a set of corresponding user selections in response to the set of financial risk preferences;
assessing the database by the processor the set of corresponding user selections to provide another set of financial risk preferences;
generating by the processor a financial risk tolerance score based on a repeated plurality of financial risk preferences and corresponding user selections.

12. A method of claim 9, further comprising:
receiving by the processor one or more sets of corresponding user selections to generate the financial risk tolerance score;
accessing the database by the processor to present an investor with at least one financial portfolio;
presenting by the processor to the investor the at least one financial portfolio;
prompting by the processor to the investor to examine the at least one financial portfolio;
promoting by the processor to the investor to apply to the at least one financial portfolio.
